(19) United States
(12) Patent Application Publication
(10) Pub. No.: US 2003/0182158 A1
(43) Pub. Date: Sep. 25, 2003

(54) Health care monitoring system and method

(76) Inventor: William Y. Son, Poway, CA (US)

Correspondence Address: FOLEY & LARDNER, 402 WEST BROADWAY, 23RD FLOOR, SAN DIEGO, CA, 92101

(21) Appl. No.: 10/104,585

(22) Filed: Mar. 21, 2002

(51) Int. Cl. G06F 17/60

(52) U.S. Cl. 705/2

(57) ABSTRACT

A monitoring apparatus and method for a hospital or other health care facility includes a plurality of sensors for determining operating states of a plurality of devices, respectively. The devices may include a refrigerator for storing blood, medicine, foods or other substances requiring close monitoring, as well as a lock box drug cabinet, for example. Each sensor provides operating state information to a transceiver, which outputs it to an access point. The access point provides the received information to a server, which determines, based on the received information, whether or not personnel at the hospital need to be notified in order to correct a problem with one or more of the devices being monitored.

### BACKGROUND OF THE INVENTION

A. Field of the Invention

The invention relates to a health care management system and method which monitors devices and equipment within a hospital or other health care facility. In particular, the invention relates to a monitoring system and method that senses a problem with devices and equipment, which may not be functioning properly or other information may be required by personnel.

B. Description of the Related Art

The information contained in this section relates to the background of the art of the present invention without any admission as to whether or not it legally constitutes prior art.

The monitoring of devices and equipment has been performed using a variety of techniques. For example, reference may be made to the following U.S. Pat. No. 4,737,910; 4,884,208; 5,132,920; 5,671,738; 5,764,158; 5,764,159; 5,767,771; 5,844,488; 5,910,776; 6,069,570; 6,147,601; 6,160,477; and 6,211,782 B1.

The monitoring of equipment in health care facilities, such as hospitals, clinics and other, can be particularly challenging and is important for proper health care. Different types of hospital or other health care facility devices or components are required to be monitored frequently in order to assure that they are functioning properly. For example, if a problem occurs with a device or equipment, such as a refrigerator that stores donated blood or other refrigerated substances, it is vitally important that the problem be resolved quickly, or otherwise the blood or other substances may not be unusable and may have to be destroyed.

The monitoring of the hospital and health care facility devices and components is conventionally done by hospital staff, such as by nurses or orderlies, as well as by technicians, and can be a very time-consuming part of their job. For example, refrigeration units in a hospital have to be monitored periodically on a daily basis to ensure that spoilage of contents stored therein does not occur due to a refrigeration unit malfunctioning. Also, bed alarms for patients convalescing in the hospital have to be checked periodically to ensure that they are functioning properly. Still further, narcotic boxes and/or medicine cabinets should be checked periodically to ensure that they are securely locked and that nothing has been stolen from them. Also, narcotics waste tracking and equipment asset tracking should be performed in order to ensure proper handling as narcotics waste and hospital equipment are moved to desired locations within the hospital. In order to perform these tasks, a hospital staff member is required to walk to various locations within a hospital, and enter monitoring information and his/her initials onto a check sheet located nearby each device being monitored.

As explained above, nurses, orderlies and other hospital staff personnel are required to devote a good portion of their work time to monitoring various hospital devices, and thus this leaves them with less time to perform their primary duty of treating and assisting patients. As such, a hospital or other health care facility may be required to employ more staff or pay more over-time compensation in order to accomplish the needed tasks of treating and assisting patients and monitoring the various devices within the hospital or other health care facility. This increases the hospital's operating expenses.

It is desired to provide an apparatus and a method to increase the effectiveness and efficiency of monitoring devices and equipment in a health care facility. The amount of time that staff is required to devote to monitoring the equipment is lessened.

### BRIEF DESCRIPTION OF THE DRAWINGS

The foregoing advantages and features of the disclosed embodiments of the present invention will become apparent upon reference to the following detailed description and the accompanying drawings, of which:

FIG. 1 is a block diagram of a network connection of various elements used in a monitoring system according to an embodiment of the invention;

FIG. 2 is a block diagram of one possible configuration of a Collection Point that may be utilized in the system according to an embodiment of the invention;

FIG. 3 is a block diagram of an Access Point that may be utilized in the monitoring system according to an embodiment of the invention;

FIG. 4 is a detailed block diagram of the Collection Point of FIG. 2.

FIG. 5 is a block diagram of a server that may be utilized in the monitoring system according to an embodiment of the invention;

FIG. 6 is a flow diagram showing the steps performed by an Access Point according to an embodiment of the invention; and

FIG. 7 is a flow diagram showing the steps performed by a Collection Point according to an embodiment of the invention.

### DETAILED DESCRIPTION OF SPECIFIC EMBODIMENTS

The disclosed embodiments of the present invention are directed to an apparatus and a method for monitoring at least one device at a hospital or other health care facility.

According to one aspect of the disclosed embodiments of the invention, there is provided a method of monitoring at least one device in a health care facility. The method includes sensing, at a first location, whether or not the at least one device is operating normally. The method also includes transmitting, at the first location, an indication of whether or not the at least one device is operating normally. The method further includes receiving, at a second location, the indication. The method still further includes sending, when the at least one device is not operating normally, an indication to a device operated by a worker at the health care facility to inform the worker that the device is not operating normally and needs to be fixed.

According to another aspect of another example of the invention, there is provided a monitoring apparatus for monitoring a device at a health care facility. The monitoring apparatus includes a sensor communicatively coupled to the device and configured to determine an operating state of the device and to output a first signal indicative thereof. The monitoring apparatus also includes a first transceiver communicatively coupled to the sensor by way of a first communication line and configured to receive the first signal and the output the first signal over-the-air as a wireless first signal. The monitoring apparatus further includes a second transceiver located separate from the first transceiver and configured to receive the wireless first signal and to output the wireless first signal as a second signal onto a second communication line. The monitoring apparatus still further includes a server that is configured to receive the second signal and to determine, based on the operating state of the device as determined from the second signal, whether or not to send a notification signal to at least one of a plurality of computer devices communicatively coupled to the server.

According to yet another aspect of the invention, there is provided a monitoring apparatus for monitoring a plurality of devices at a health care facility. The monitoring apparatus includes a plurality of collection points communicatively coupled to the plurality of devices, respectively, and configured to determine an operating state of the plurality of devices and to output first signals indicative thereof. The monitoring apparatus also includes an access point configure to receive the first signals output by the plurality of collection points and to forward the first signals onto a communication line. The monitoring apparatus further includes a server that is configured to receive the first signals on the communication line and to determine, based on the respective operating states of the plurality of devices as determined from the first signals, whether or not to send at least one notification signal to at least one of a plurality of computer devices communicatively coupled to the server.

Preferred embodiments of the invention will now be described in detail below, with reference to the accompanying drawings.

The invention will be described below with reference to a large health care facility, such as a University Medical Center. One of ordinary skill in the art will recognize that the invention is applicable to other types of health care facilities, such as a nursing home, a hospital ward or an emergency room.

Blood products, breast milk and critical drugs require careful refrigeration, and thus the refrigeration units storing these things have to be monitored frequently. Also, certain drugs are required to be stored in a secure location, such as in a locked cabinet, and these cabinets need to be monitored frequently to ensure that no theft of drugs has taken place.

As explained earlier, conventional hospital equipment monitoring systems and methods used by hospitals and other health care facilities are very labor-intensive. This results in greater operating costs due to a hospital having to hire more nurses, orderlies and other hospital staff to perform both device monitoring and patient care and treatment.

The disclosed embodiments of the present invention enable an efficient and effective monitoring system and method. Such a system and method lessens the time needed by hospital staff to perform hospital device monitoring duties, and lessens the number of hospital staff personnel needed to perform both hospital device monitoring and patient care and treatment.

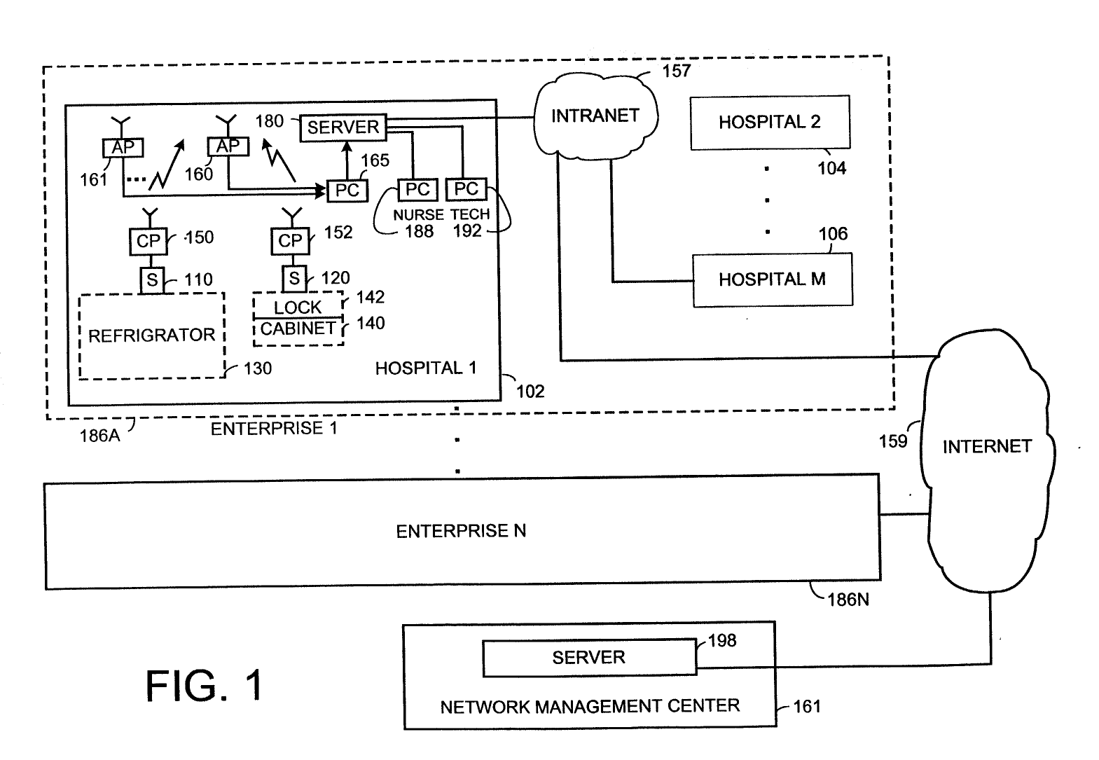

An embodiment of the invention is shown in FIG. 1. In that figure, a remote sensor is provided at each hospital device that requires monitoring, whereby a first sensor 110 and a second sensor 120 for respectively monitoring the operation of a refrigerator 130 and a drug cabinet 140 are shown. The first and second sensors 110, 120 are standard sensors, such as those known to one of ordinary skill in the art. For example, the first sensor 110 may be a magnetic sensor that is capable of determining if the door of the refrigerator 130 is opened or closed, whereby it outputs a first type signal indicative of the refrigerator door being opened for greater than a predetermined period of time (e.g., greater than one minute). It will become apparent to those skilled in the art that there may be additional types and kinds of sensors (not shown) that may also be utilized. For example, there may be sensors employed for tracking the location of portable or mobile equipment.

The first sensor 110 is also capable of determining the current temperature within the refrigerator 130, whereby it outputs a second type signal indicative of the refrigeration temperature being outside of an acceptable refrigeration range. The sensor 180 determines the acceptable duration of an out of range criteria set by the hospital staff. The first sensor 110 also preferably outputs an “I'm alive” (third type) signal periodically (e.g., every minute) that is used to verify that the first sensor 110 is operating normally. Alternatively, the temperature sensing and door open/closed sensing may be performed by two separate sensors coupled to the refrigerator 130, whereby these two sensors would correspond to the first sensor 110 referred to hereinabove.

The second sensor 120 is coupled to the drug cabinet 140 and functions to determine whether or not a lock 142 of the drug cabinet 140 has been tampered with, and/or whether or not a door of the drug cabinet 140 has been opened, or the lock 142 is in an unlocked condition. If one of these events occurs, a fourth type signal is output by the second sensor 120. The second sensor 120 may preferably output an “I'm alive” (third type) signal periodically that is used to verify that the second sensor 120 is operating normally. The second sensor can be interconnected to any existing lock box cabinet that may have a security panel with password protection. By interconnecting with the security panel, the preferred embodiment of the present invention can detect and notify the user in real time of an unauthorized attempted entry, or block such entry.

In one configuration, the first and second sensors 110, 120 output the “I'm alive” signals periodically irrespective as to whether or not they are polled, and in an alternative configuration, the first and second sensors 110, 120 output the “I'm alive” signals only after they have been polled (such as by a server 180 sending a request for the sensors to output an “I'm alive” signal).

Signals output by the first sensor 110 are received by a first collection point 150, which preferably transmits those signals, over-the-air, in a wireless manner and at a predetermined frequency channel, to an access point 160.

The first collection point 150 is preferably located nearby the first sensor 110, and is communicatively connected to the first sensor 110 by way of a first wired connection. Alternatively, the first sensor 110 may be communicatively connected to the first collection point 150 by way of a wireless (e.g., IR or RF) means. In this embodiment, the access point 160 is disposed at a separate location, such as a location nearby any intranet connection within the enterprise. It is to be understood that depending on the number and location of the sensors, a group of similar access points, such as a like access point 161, may be employed and are distributed throughout the facility.

Signals output by the second sensor 120 are received by a second collection point 152. The second collection point 152 transmits the signals that it receives, preferably over-the-air, in a wireless manner and at a predetermined frequency channel, to the access point 160. The second collection point 152 is preferably located nearby the second sensor 120, and is communicatively connected to the second sensor 120 by way of a second wired connection. Alternatively, the second sensor 120 may be communicatively connected to the second sensor 120 by way of wireless means.

The access point 160 provides the signals output by the first and second collection points 150, 152 to the server 180. The access point 160 is located on a network, and routes signals to their proper locations, in a manner known to those skilled in the art (e.g., reads address information from a data packet on the network to determine the appropriate destination from the data packet). All of the elements described above are preferably located within a first hospital 102, whereby a second hospital 104 and a third hospital 106 of the same enterprise may be communicatively connected to the first hospital 102 by way of an Intranet 157, such as a local area network (LAN) or a wide area network (WAN). Additional hospital (not shown) may also form a part of the same enterprise, and communicate via the intranet 157. Alternatively, units 102, 104 may correspond to different wards of one hospital.

The second and third hospitals 104, 106 have similar components in their monitoring systems as shown for the first hospital 102. The network connection of the first, second and third hospitals 102, 104, 106 is referred to as a first enterprise 186A. Second through the last or n^{th} enterprises 186B-186N are also shown in FIG. 1, whereby each of the enterprises 186A-186N preferably communicates with a second server 198 (at a service center, to be explained in more detail below) by way of the Internet 159, or by a WAN connection.

A first personal computer 188 and a second personal computer 192 within the first hospital 102 are shown in FIG. 1 as being communicatively connected to the first server 180. The connection of these elements is via a network, such as an Ethernet, Frame Relay, or Asynchronous Transfer Mode (ATM) network, within the first hospital 102.

When a signal output from either the first sensor 110 or the second sensor 120 is received by the first server 180, it first determines what type of signal it is. For example, if it is a first type (refrigerator door open) signal output from the first sensor 110, then the first server 180, by way of an application program stored therein (in a Read-Only-Memory of the first server 180 or in a memory separate from the first server 180 but accessible by the first server 180), determines that a notification is to be sent to the first personal computer 188. The notification is in the form of a flashing icon of the equipment or unit in question, together with an audible alarm or buzzer to attract the attention of the user. The collection point 150 also flashes a warning light and sounds a warning buzzer to attract attention. The first personal computer 188 may be, for example, a computer used by a nurse assigned to an area nearby the refrigerator, whereby the nurse, once notified, can then fix the problem by going to the refrigerator and closing the door of the refrigerator 130. “B” The first personal computer 188 may alternatively be a nurse's pager, whereby the nurse is paged by way of the notification. The page may include a brief message (displayed on the pager) as to the “what and where” of the problem to be fixed by the nurse. In general, the server 180 stores signals in digital format for future retrieval at a later time for report generation purposes.

When the first server 180 receives a second type (e.g., malfunctioning cooling unit in a refrigerator) signal output from the first sensor 110, then the application program of the first server, 110 determines that a notification is to be sent to the second personal computer 192, as well as to the first computer 188, if desired. The second personal computer 192 may be, for example, a personal computer (or it may be a pager) used by a hospital technician who is trained to fix refrigerators, since a type two signal is most likely a problem that cannot be fixed by a nurse who is not trained to fix refrigerators.

The application program of the first server 180 may be programmed such that, if a first nurse has not responded to a first type signal for a particular time period (e.g., 10 minutes), then another nurse who is stationed nearby where the problem is located is then notified. This procedure may be continued until the problem is rectified.

The first server 180 keeps track of the signals received from the first and second sensors 110, 120, and maintains a running record of the operability of the various devices in the first hospital 102.

The running record is stored in a database, whereby that information may be used for safety and quality management purposes.

The second and third hospitals 104, 106 have their own servers (not shown), if necessary, at their respective facilities to perform the same task as the first server 180. Furthermore, if a problem at the first hospital 102 cannot be resolved by the nurse and the technician at the first hospital 102, as indicated by a message sent from the first and/or second computers 188, 192 or by the continued receipt of “problem” signals from a sensor coupled to a device (e.g., refrigerator) at the first hospital 102, then the first server 180 notifies a second server 198 located at a network management center 161.

The second server 198 is communicatively connected to the first server 180 by a network connection, such as by a WAN or by the Internet. The second server 198 forwards the “problem” signal (e.g. by a paging signal, an e-mail or telephone message) to a specialized technician at or employed by a service center, who will then go to the first hospital 102 to fix the problem. Depending on the type of problem, a particular service center (e.g., cabinet repair shop or refrigeration repair shop) is notified if the problem cannot be resolved by staff at the first hospital 102.

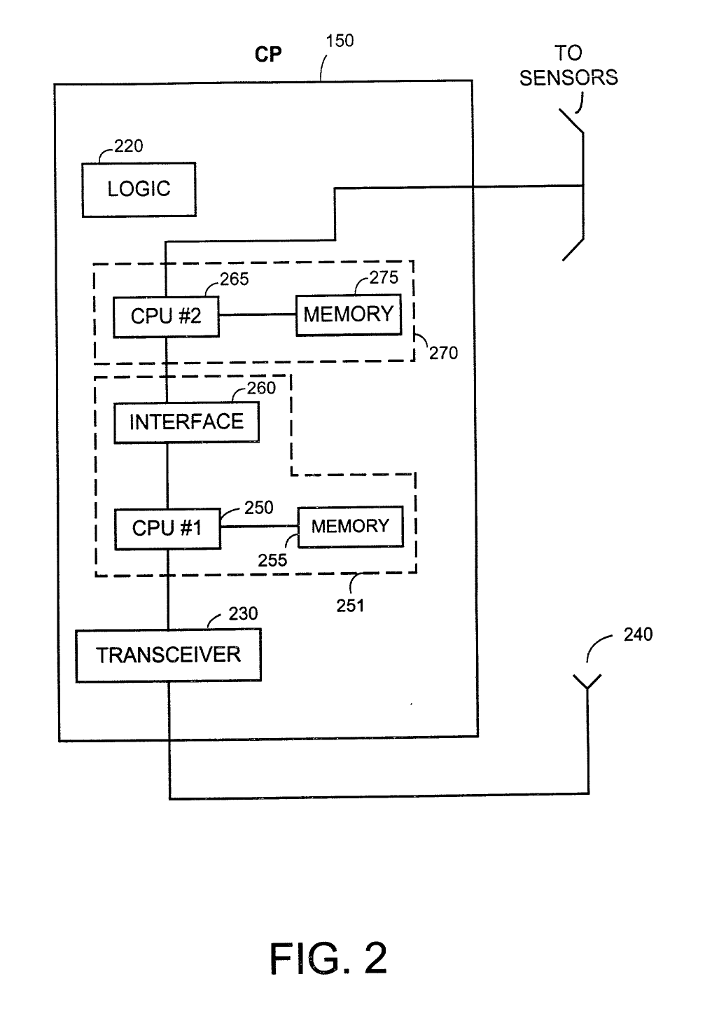

FIG. 2 shows one possible configuration of a Collection Point (CP) 150 according to an embodiment of the invention. The Collection Point 150 includes a Logic Unit 220, which provides the logic functions needed for proper operation of the Collection Point 150 and provides status indication via LEDs (not shown) as well as power management and battery back-up. The Collection Point 150 also includes an RF transceiver unit 230 which is communicatively coupled to an antenna unit 240. Also shown in FIG. 2 is a first CPU 265, which is part of a sensor controller/status management unit generally indicated at 270, and which is coupled to a first memory 275 and to an interface 260 of a main controller generally indicated at 251. The second CPU 250 provides for outputting signals in proper format to the transceiver unit 230, and it runs one or more application programs stored in the first memory 255 to accomplish this task

The interface 260 of the main controller 251 provides a data interface between the first CPU 250 and a second CPU 265 and may be a buffer or flash memory FIFO, for example. The second CPU 265 reads in sensor data and converts the sensor data to digital data in a particular format. To accomplish this data conversion, the second CPU 265 runs one or more application programs obtained from a second memory 275.

The sensor information received by the CPU 250 is then transferred to unit 251 to store into the memory 275 for future reference, and the information is transferred to transceiver 230 to be sent to the AP 160 when requested.

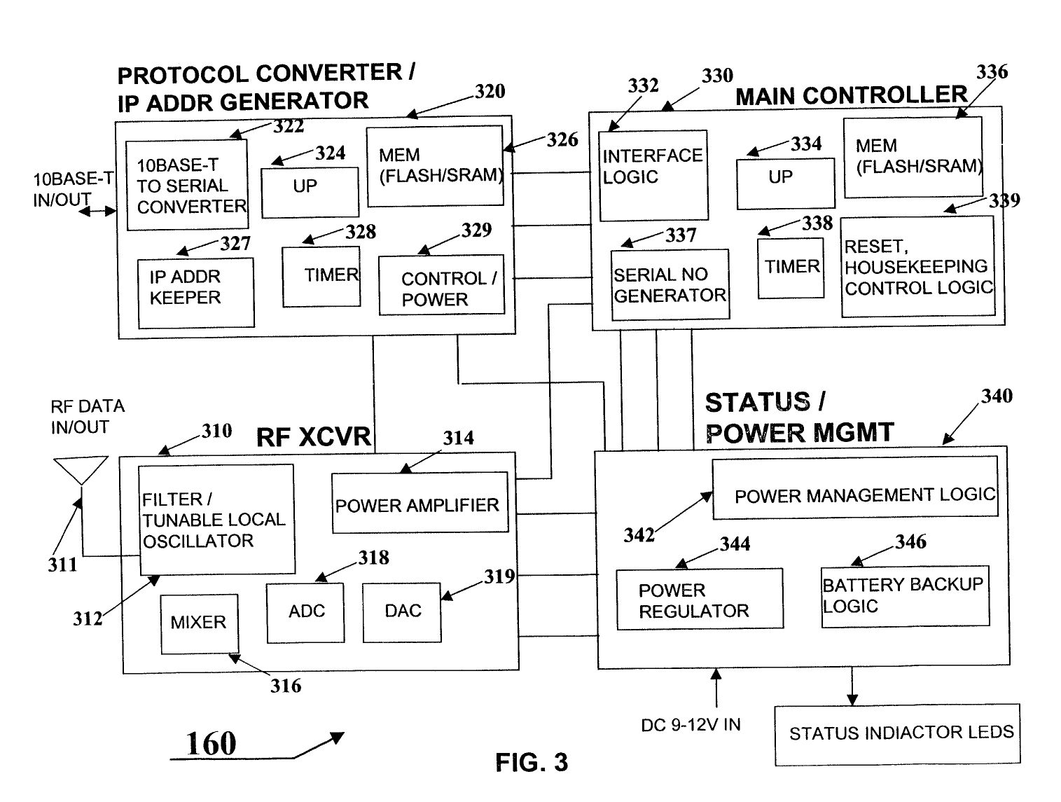

FIG. 3 is a block diagram of an Access Point (AP) 160 that may be utilized in the monitoring system according to an embodiment of the invention. The Access Point 160 includes an RF Transceiver (RF xcvr) 310, a Protocol Converter/IP Address Generator 320, a Main Controller 330, and a Status/Power Management Unit 340.

The RF Transceiver 310 includes an antenna 311, which receives and transmits signals over-the-air, in a wireless manner, to/from one or more Collection Points 150 assigned to communicate with the Access Point 160. The RF Transceiver 310 also includes a Filter/Tunable Local Oscillator 312, a Power Amplifier 314, a Mixer 316, an Analog-to-Digital Converter (ADC) 318, and a Digital-to-Analog Converter (DAC) 319. When an RF signal is received by the Antenna 311, then the Filter/Tunable Local Oscillator 312, the Power Amplifier 314, the Mixer 316, the Analog-to-Digital Converter (ADC) 318, and the Digital-to-Analog Converter (DAC) 319 are utilized to provide an intermediate frequency signal which is then converted to a baseband signal and then to a digital signal, in a manner known to those skilled in the art. Similarly, a digital signal to be transmitted by the RF Transceiver 310 over-the-air, are converted to an RF signal by way of the Filter/Tunable Local Oscillator 312, the Power Amplifier 314, the Mixer 316, the Analog-to-Digital Converter (ADC) 318, and the Digital-to-Analog Converter (DAC) 319, in a manner known to those skilled in the art.

The Protocol Converter/IP Address Generator 320 receives and outputs a 10Base-T signal (or other type of digital signal), to thereby send and receive signals from a network (e.g., Ethernet). The Protocol Converter/IP Address Generator 320 includes a 10Base-T-to-Serial Converter 322, a Microprocessor (μP) 324, a Memory 326 (e.g., Flash Memory/Static Random Access Memory), an IP Address Keeper 327, a Timer 328, and a Control/Power Unit 329. The 10Base-T-to-Serial Converter 322, the Microprocessor (μP) 324, the Memory 326, the IP Address Keeper 327, the Timer 328, and the Control/Power Unit 329 are utilized in protocol conversion and IP address generator for digital data to be sent out by and that is received by the Access Point 160. In particular, application programs run by the Microprocessor 324 (as obtained from the Memory 326) are used to provide the protocol conversion and IP Address Generator functions for the Protocol Converter/IP Address Generator 320.

The Main Controller 330 includes an Interface Logic Unit 332, a Microprocessor (μP) 334, a Memory 336 (e.g., Flash Memory/Static Random Access Memory), a Serial Number Generator 337, a Timer 338, and a Reset and Housekeeping Control Logic Unit 339. The Main Controller 330 provides the controller functions (by way of one or more application programs run by the Microprocessor 334) for the Access Point 160, and is also used to reset the Access Point 160 and to provide general housekeeping duties for the Access Point 160.

The Status/Power Management Unit 340 includes a Power Management Logic Unit 342, a Power Regulator Unit 344, and a Battery Backup Logic Unit 346. The Status/Power Management Unit 340 provides the power and status information for the Access Point 160. For example, in conjunction with the Main Controller 330, the Status/Power Management Unit 440 outputs “I'm Alive” signals either periodically or upon request (such as by a request made by the server). A DC voltage (e.g., 9-12 volts) is provided (by way of a DC voltage source, not shown) to the Status/Power Management Unit 340. The Status/Power Management Unit 440 also provides status indication signals to a plurality of Status Indicator LEDs (not shown). These LEDs can be visually inspected (such as by a nurse or orderly) to ensure that the Access Point 160 is operating normally.

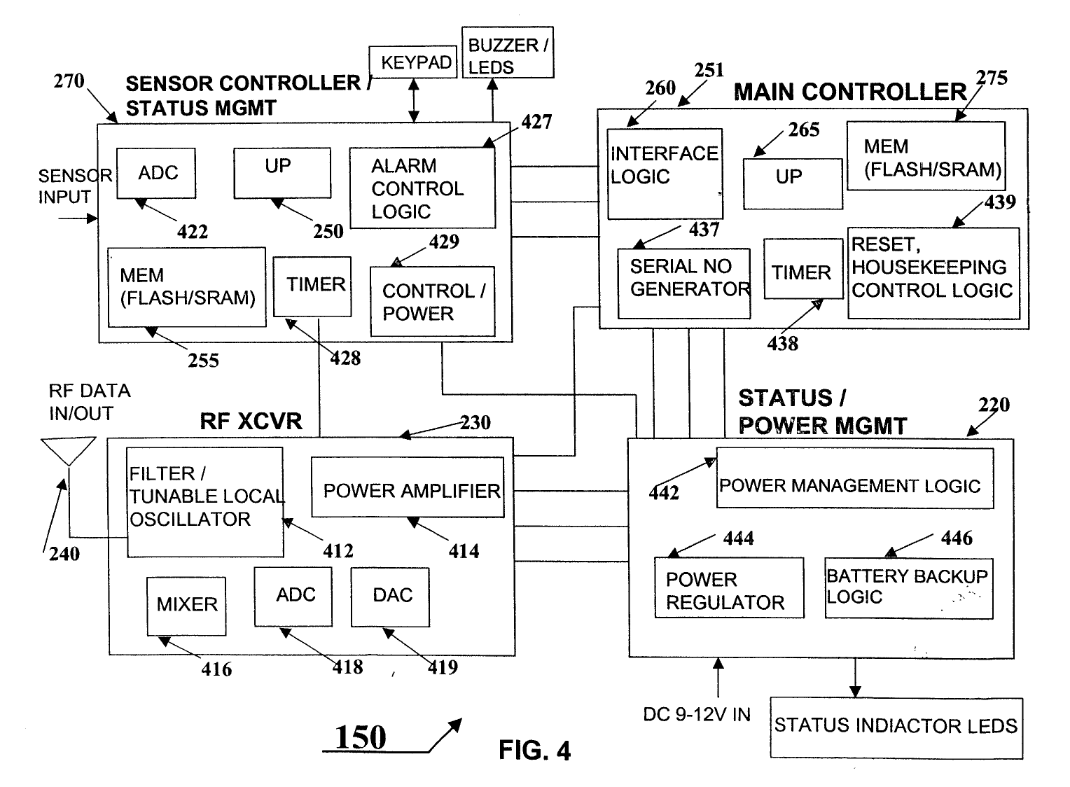

FIG. 4 is a more detailed block diagram of a Collection Point 150 of FIG. 2. The Collection Point 150 includes the RF Transceiver (RF xcvr) 230, a Sensor Controller/Status Management Unit 251, a Main Controller 270, and a Status/Power Management Unit 220.

The RF Transceiver 230 includes the antenna 240, which receives and transmits signals over-the-air, in a wireless manner, to/from an Access Point 160 assigned to receive signals from the Collection Point 150. The RF Transceiver 240 also includes a Filter/Tunable Local Oscillator 412, a Power Amplifier 414, a Mixer 416, an Analog-to-Digital Converter (ADC) 418, and a Digital-to-Analog Converter (DAC) 419. When an RF signal (output by the Access Point 160, for example) is received by the Antenna 240, then the Filter/Tunable Local Oscillator 412, the Power Amplifier 414, the Mixer 416, the Analog-to-Digital Converter (ADC) 418, and the Digital-to-Analog Converter (DAC) 419 are utilized to provide an intermediate frequency signal which is then converted to a baseband signal and then to a digital signal, in a manner known to those skilled in the art. Similarly, a digital signal to be transmitted by the RF Transceiver 230 over-the-air (to the Access Point 160), are converted to an RF signal by way of the Filter/Tunable Local Oscillator 412, the Power Amplifier 414, the Mixer 416, the Analog-to-Digital Converter (ADC) 418, and the Digital-to-Analog Converter (DAC) 419, in a manner known to those skilled in the art.

The Sensor Controller/Status Management Unit 251 receives a sensor input from a device (e.g., refrigerator coupled to it). A sensor (not shown in FIG. 4, but see FIG. 1) coupled to the hospital device provides the sensor input (e.g., refrigerator door open, refrigerator door closed) to the Sensor Controller/Status Management Unit 251. The Sensor Controller/Status Management Unit 251 includes an Analog-to-Digital Converter (ADC) 422, which converts the analog sensor input to a digital signal. The Sensor Controller/Status Management Unit 420 also includes the Microprocessor (μP) 250, a Memory 255 (e.g., Flash Memory/Static Random Access Memory), a Timer 428, and a Control/Power Unit 429. The Microprocessor 250 is utilized to run application programs (obtained from the Memory 255) to provide control of the sensor (coupled to the Collection Point 150) and to perform status management functions.

An alarm control logic unit 427 provides alarm signals to one or more buzzers and LEDs, to thereby provide both an audible and visual warning of a problem. A keypad is coupled to the Sensor Controller/Status Management Unit 251, to enable a user to type instructions that can be read by the microprocessor 250.

The Main Controller 270 includes the Interface Logic Unit 260, the Microprocessor (μP) 265, the Memory 275 (e.g., Flash Memory/Static Random Access Memory), a Serial Number Generator 437, a Timer 438, and a Reset and Housekeeping Control Logic Unit 439. The Main Controller 270 provides the controller functions (by way of one or more application programs run by the Microprocessor 265) for the Collection Point 150, and is also used to reset the Collection Point 150 and to provide general housekeeping duties for the Collection Point 150.

The Status/Power Management Unit 220 includes a Power Management Logic Unit 442, a Power Regulator Unit 444, and a Battery Backup Logic Unit 446. The Status/Power Management Unit 220 provides the power and status information for the Collection Point 150. For example, in conjunction with the Main Controller 270, the Status/Power Management Unit 220 outputs “I'm Alive” signals either periodically or upon request (such as by a request made by the server 180). A DC voltage (e.g., 9-12 volts) is provided to the Status/Power Management Unit 220 (by way of a DC voltage source, not shown). The Status/Power Management Unit 220 outputs status management signals to a plurality of Status Indicator LEDs (not shown), which can be visually inspected (such as by a nurse or orderly) to ensure that the Collection Point 150 is operating normally.

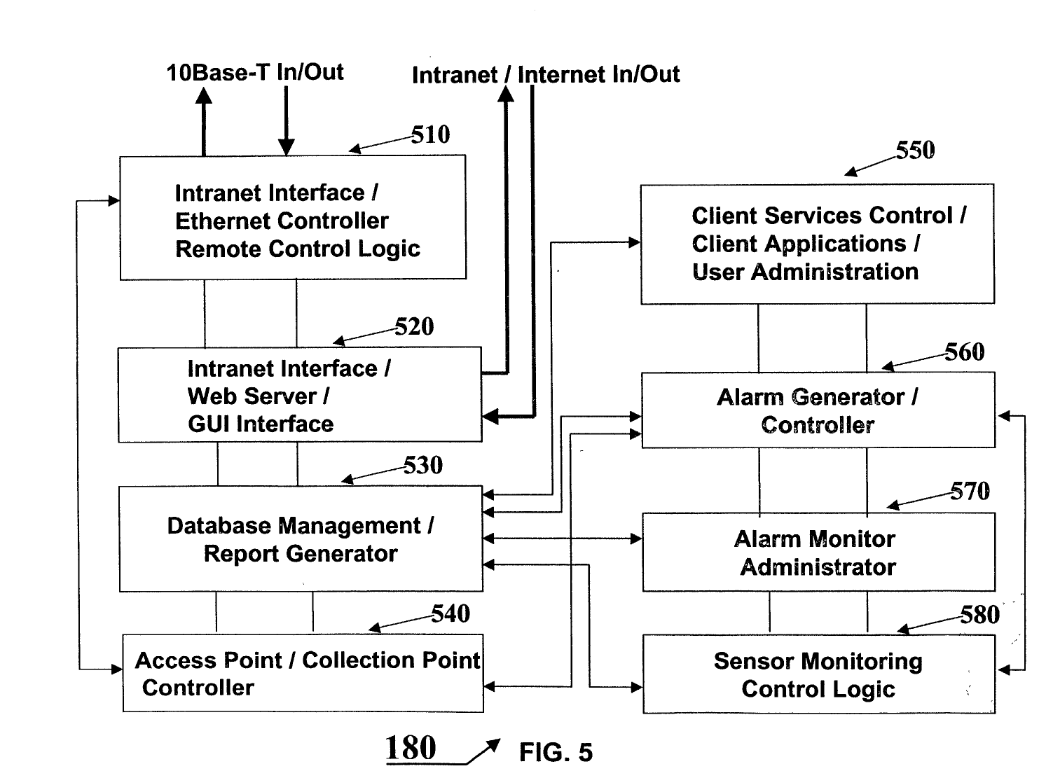

FIG. 5 is a block diagram showing various elements of the server 180 that may be utilized for the monitoring system and method of the preferred embodiment of the invention. The server 198, shown in FIG. 1, may also be similar to the server 180.

The server 180 includes an Intranet Interface/Ethernet Controller Remote Control Logic Unit 510, which receives signals from other devices (e.g., personal computers, nodes, etc.) over a network, whereby those signals may be 10Base-T signals, for example. The Intranet Interface/Ethernet Controller Remote Control Logic Unit 510 also outputs signals in proper format (10Base-T format) from the server 180 to the network that communicatively couples the server 180 to other devices.

The server 180 also includes an Intranet Interface/Web Server/GUI Interface Unit 520, which provides the control for interfacing with the Intranet or with the Internet (to communicate with devices over the Intranet or the Internet, for example), and which provides a graphical user interface control for the server 180.

The server 180 further includes a Database Management/Report Generator Unit 530, which is used to provide reports with respect to monitoring of hospital devices, and which reads data from and writes data to a database in which monitoring information is stored.

The server 180 also includes an Access Point/Collection Point Controller 540, which provides control signals to various Access Points and Collection Points within the monitoring system, such as to send signals to control one or more of those devices to output “I'm Alive” signals based on a signal output by the server 180. The server 180 stores at least some or all of the signal received.

The server 180 still further includes a Client Service Control/Client Applications/User Administration Unit 550, which provides for client service control, which provides an interface for one or more client applications, and which provides user administration functions for the server 180.

The server 180 also includes an Alarm Generator/Controller 560, which outputs an alarm, such as an audible alarm, a visual alarm, and/or a signal indicating a problem with the server 180, so that the server 180 can be repaired in a timely manner.

The server 180 further includes an Alarm Monitor Administrator 570, which monitors the alarms output by the server 180, as well as monitoring the alarms output by other devices in the monitoring system according to the invention.

The server 180 also includes a Sensor Monitoring Control Logic Unit 580, which provides control for the various sensors coupled to the various hospital devices to be monitored within the system according to the invention. The Sensor Monitoring Control Logic Unit 580 may output signals for causing one or more sensors to be reset, or to output a signal indicative that they are currently operational, for example.

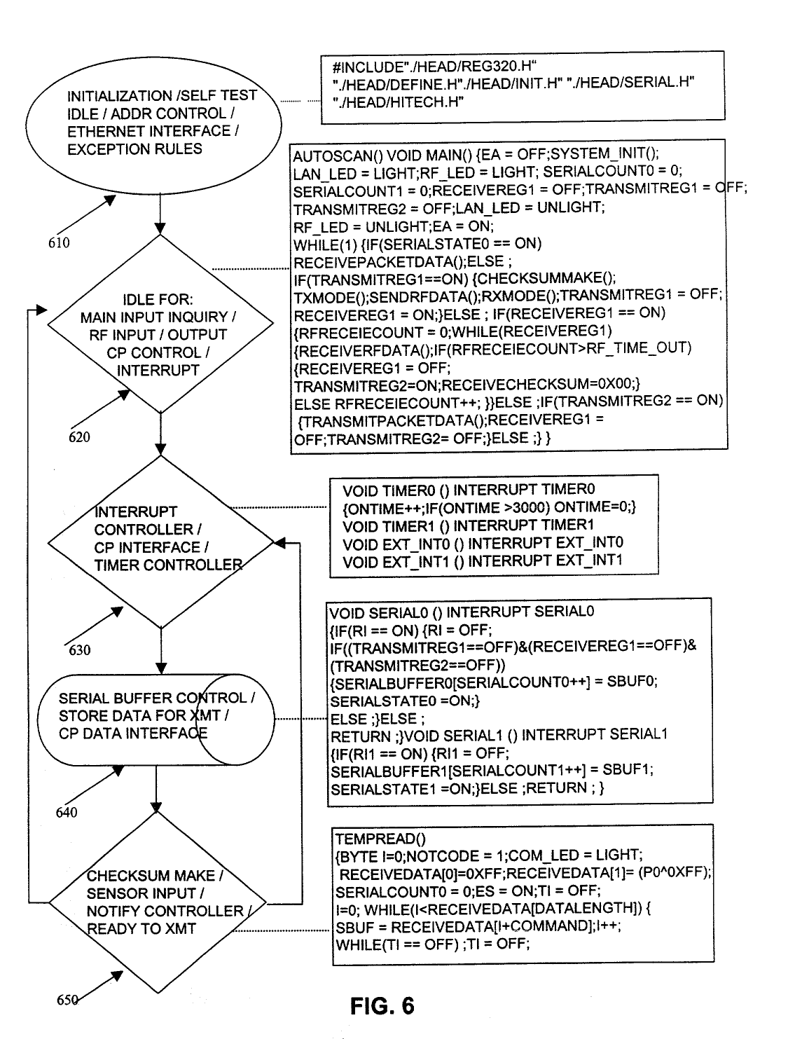

FIG. 6 is a flow diagram of various steps performed by an Access Point 160 according to the embodiment of the invention. Also shown in FIG. 6 is representative software to execute the steps shown in that figure. The Access Point 160 performs a first step 610 of Initialization, Self Test, Idle Address Control, Ethernet Interface functions, and Exception Rules. The first step 610 is preferably performed soon after the Access Point 160 is initially turned on from an off state.

The Access Point 160 performs a second step 620, which is an Idle step for: main input inquiry, RF Input, output Collection Point control, and Interrupt. This is a step that the Access Point 160 typically is in during operation, whereby the Access Point 160 is waiting for monitoring signals sent from Collection Points 160 or from the server 180, for example.

The Access Point 160 performs a third step 630, which is a step that includes Interrupt Control, Collection Point Interface, and Timer Control. When a signal is received from a Collection Point 150, the third step 630 is performed by the Access Point 160, whereby the Access Point 160 transitions from the Idle second step 620 to the third step 630.

After completing the third step 630, the Access Point 160 performs a fourth step 640, which is a step that includes Serial Buffer Control, Storing of Data for Transmit, and Collection Point Interface. The fourth step 640 involves the receipt of data from one or more Collection Points 150 and the storing of that data for transfer to other devices, as well as interface control with the collection point communicating with the Access Point 160.

After completing the fourth step 640, the Access Point performs a fifth step 650, which is a step that includes Check Sum processing, Sensor Input processing, Notify Controller functions, and Ready-to-Transmit functions. The fifth step 650 performs functions that are required to transmit data properly from the Access Point 160 to other devices, such as the Server 180 or a Collection Point 150. Upon completion of the fifth step 650, whereby data is transmitted out from the Access Point 160 to a desired component, the process returns to the “Idle” second step 620. If not all of the data has been transmitted out from the Access Point 160, the process returns to the third step 630 to process the remaining data to be transmitted, before the entire amount of data is to be sent out in the fifth step 650.

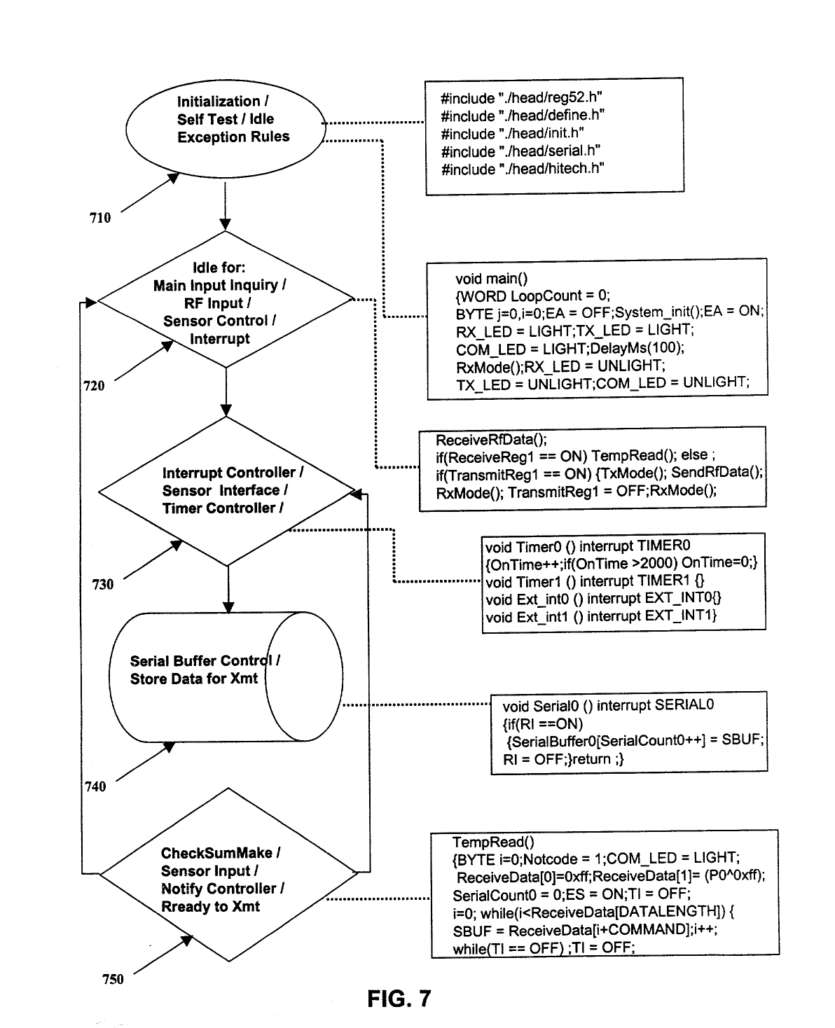

FIG. 7 is a flow diagram of various steps performed by the Collection Points 150 according to the embodiment of the invention. Also shown in FIG. 7 is representative software to execute the steps shown in that figure. A Collection Point 150 performs a first step 710 of Initialization, Self Test, and Idle Exception Rules. The first step 710 is preferably performed soon after the Collection Point 150 is initially turned on from an off state.

The Collection Point 150 performs a second step 720, which is an Idle step for: main input inquiry, RF Input, Sensor control, and Interrupt. This is a step that the Collection Point 150 typically is operating in during its normal operating mode, whereby the Collection Point 150 is waiting for signals output from one or more sensors communicatively connected to the Collection Point 150, for example.

The Collection Point 150 performs a third step 730, which is a step that includes Interrupt Control, Sensor Interface functions, and Timer Control. When a signal is received from a sensor coupled to the Collection Point 150, the third step 730 is performed by the Collection Point 150, whereby the Collection Point transitions from the “Idle” second step 720 to the third step 730.

After completing the third step 730, the Collection Point 150 performs a fourth step 740, which is a step that includes Serial Buffer Control, and Storing of Data for Transmit. The fourth step 740 involves the receipt of data from one or more sensors and the storing of that data for transfer to an Access Point 160 that is assigned to communicate with the Collection Point 150.

After completing the fourth step 740, the Collection Point 150 performs a fifth step 750, which is a step that includes Check Sum processing, Sensor Input processing, Notify Controller functions, and Ready-to-Transmit functions. The fifth step 750 is a step in which functions are performed in order to transmit data in proper format (and protocol) from the Collection Point 150 to the Access Point 160. Upon completion of the fifth step 750, whereby monitoring data is transmitted out from the Collection Point 150, the process returns to the “Idle” second step 720. If not all of the monitoring data has been transmitted out from the Collection Point 150, the process returns to the third step 730 to process the remaining data to be transmitted, before the entire amount of data is to be sent out in the fifth step 750.

Different embodiments of the present invention have been described according to the present invention. Many modifications and variations may be made to the techniques and structures described and illustrated herein without departing from the spirit and scope of the invention. Accordingly, it should be understood that the apparatuses described herein are illustrative only and are not limiting upon the scope of the invention.

What is claimed is:

1. A method of monitoring at least one device in a health care facility, comprising:
sensing, at a first location, whether or not said at least one device is operating normally;
transmitting, at said first location, an indication of whether or not said at least one device is operating normally;
receiving, at a second location, the indication; and
sending, when the at least one device is not operating normally, an indication to a device operated by a worker at the health care facility to inform the worker that the device is not operating normally and needs to be fixed.

2. The method according to claim 1, wherein, when the indication is that the at least one device is not operating normally, the notification is sent to a two-way communication device.

3. The method according to claim 2, wherein the worker is one of a nurse and an orderly at the hospital.

4. The method according to claim 1, wherein the sensing step is performed at periodic intervals.

5. The method according to claim 1, wherein the at least one device includes a refrigerating unit.

6. The method according to claim 1, wherein the at least one device includes a locking cabinet that is configured to securely store drugs.

7. The method according to claim 2, wherein, when the sensing step continues to output the indication that the at least one device is not operating normally for a time period greater than a first time amount after when the notification was sent in the sending step, the method further comprises the step of:
sending the notification to another worker to inform the another worker that the device is not operating normally and needs to be fixed.

8. The method according to claim 2, wherein the worker is a nurse, and the another worker is a technician.

9. A monitoring apparatus for monitoring a device at a health care facility, comprising:
a sensor communicatively coupled to the device and configured to determine an operating state of the device and to output a first signal indicative thereof;
a first transceiver communicatively coupled to the sensor by way of a first communication line and configured to receive the first signal and the output the first signal over-the-air as a wireless first signal;
a second transceiver located separate from the first transceiver and configured to receive the wireless first signal and to output the wireless first signal as a second signal onto a second communication line; and
a server that is configured to receive the second signal and to determine, based on the operating state of the device as determined from the second signal, whether or not to send a notification signal to at least one of a plurality of computer devices communicatively coupled to the server.

10. The monitoring apparatus according to claim 9, wherein the at least one of a plurality of computer devices includes a personal computer.

11. The monitoring apparatus according to claim 9, wherein the at least one of a plurality of computer devices includes a pager.

12. The monitoring apparatus according to claim 9, wherein the at least one device includes a refrigeration unit.

13. The monitoring apparatus according to claim 9, wherein the least one device includes a locking cabinet that is configured to securely store drugs.

14. The monitoring apparatus according to claim 9, further comprising:
a second server operatively connected to the server by one of a Wide Area Network and an Internet,
wherein, when the server determines that the at least one device is not operating in a normal state for at least a period of time after the notification has been sent out by the server, the server sends the notification to the second server.

15. The monitoring apparatus according to claim 14, wherein the second server is located at a service center, and wherein a repairperson of the service center is notified of the at least one device not being in the normal state so as to effect a repair of the at least one device.

16. The monitoring apparatus according to claim 9, wherein the first transceiver includes:
a sensor controller and status management unit for receiving signals output from the sensor and to provide signals to the sensor, and to manage status of the first transceiver;
a transceiver unit that is configured to communicate with the second transceiver in a wireless manner;
a main controller for controlling operation of the first transceiver; and
a status and power management unit for providing status information of the first transceiver and for providing power to the first transceiver.

17. The monitoring apparatus according to claim 16, wherein the second transceiver includes:
a protocol converter and IP address generator unit for converting signals in a proper format for communicating with the first server over a network;
a transceiver unit that is configured to communicate with the first transceiver in a wireless manner;
a main controller for controlling operation of the second transceiver; and
a status and power management unit for providing status information of the second transceiver and for providing power to the second transceiver.

18. A monitoring apparatus for monitoring a plurality of devices at a health care facility, comprising:
a plurality of collection points communicatively coupled to the plurality of devices, respectively, and configured to determine an operating state of the plurality of devices and to output first signals indicative thereof;
an access point configure to receive the first signals output by the plurality of collection points and to forward the first signals onto a communication line; and
a server that is configured to receive the first signals on the communication line and to determine, based on the respective operating states of the plurality of devices as determined from the first signals, whether or not to send at least one notification signal to at least one of a plurality of computer devices communicatively coupled to the server.

19. The monitoring apparatus according to claim 18, wherein each of the plurality of collection points includes at least one sensor and a transceiver.

20. The monitoring apparatus according to claim 18, further comprising a second access point,
wherein a first subset of the plurality of collection points outputs the respective first signals to the access point and a second subset of the plurality of collection points outputs the respective first signals to the second access point.

21. The monitoring apparatus according to claim 20, wherein the access point and the second access point provide the respective first signals to the server by way of one of a local area network and a wide area network.

22. The monitoring apparatus according to claim 20, further comprising:
a second server operatively connected to the server by one of a Wide Area Network and an Internet,
wherein, when the server determines that one of the devices is not operating in a normal state for at least a period of time after the notification has been sent out by the server, the server sends the notification to the second server for the second server to notify others with respect to correcting the operating state of the one of the devices.

23. The monitoring apparatus according to claim 18, wherein each of the collection points includes:
a sensor controller and status management unit for receiving signals output from the sensor and to provide signals to the sensor, and to manage status of the respective collection point;
a transceiver unit that is configured to communicate with the access point in a wireless manner;
a main controller for controlling operation of the respective collection point; and
a status and power management unit for providing status information of the respective collection point and for providing power to the respective collection point.

24. The monitoring apparatus according to claim 23, wherein the access point includes:
a protocol converter and IP address generator unit for converting signals in a proper format for communicating with the server over a network;
a transceiver unit that is configured to communicate with at least one of the plurality of collection points assigned thereto in a wireless manner;
a main controller for controlling operation of the access point; and
a status and power management unit for providing status information of the access point and for providing power to the access point.
